(19) United States
(12) Patent Application Publication
(10) Pub. No.: US 2019/0333147 A1
(43) Pub. Date: Oct. 31, 2019

(54) PEER-TO-PEER DATABASE PROTOCOL FOR DISTRIBUTED LEDGER TECHNOLOGY (DLT)-BASED TOKENS

(71) Applicant: Swap Holdings Limited, Central (HK)

(72) Inventors: Michael Oved, Brooklyn, NY (US); Donald C. Mosites, Brooklyn, NY (US)

(21) Appl. No.: 15/967,568

(22) Filed: Apr. 30, 2018

(51) Int. Cl. G06Q 40/04; G06Q 20/22; G06Q 20/06

(52) U.S. Cl. CPC G06Q 40/04; G06Q 20/36; G06Q 20/0658; G06Q 20/223

(57) ABSTRACT

The present disclosure includes a system for generating and maintaining a peer-to-peer, distributed ledger technology (DLT)-based asset index. The system may include at least one memory storing instructions and at least one processor configured to receive, from a plurality of first devices, intent indicators, each indicator including a first identifier for a first DLT-based asset and a second identifier for a second DLT-based asset; index the intent indicators based on the first identifier and the second identifier; receive, from a second device, a query that includes the first identifier and the second identifier; execute the query against the indexed intent indicators to generate one or more results; in response to the received query, transmit an order indicator to one or more of the plurality of first devices associated with the one or more results; receive, from at least one of the one or more first devices, at least one signed order for the first asset and the second asset; and transmit the at least one signed order to the second device such that the at least one signed order is selectable and executable.

### TECHNICAL FIELD

The present disclosure relates generally to the field of distributed ledger technology (DLT)-based assets. More specifically, and without limitation, this disclosure relates to systems and methods for a peer-to-peer protocol and database for exchange of DLT-based assets.

### BACKGROUND

Distributed ledger technology (DLT) has allowed for a variety of cryptocurrencies and/or tokens to be created using various protocols. The most common protocol is blockchain and is employed by many currencies and tokens, such as Ethereum, Bitcoin, and the like. Other protocols have also been developed using the core tenets of distributed ledger technology, such as directed acyclic graphs (DAGs) as used in IOTA and Hashgraph.

Given the increased production of DLT-based assets, exchanging these assets became inevitable. The first wave of such trading platforms were known as centralized exchanges. Centralized exchanges are central in implementation, which means that the exchanges require traders to (1) give up control to their assets, (2) pay a transaction fee, (3) rely on the exchanges to match-make orders and finally, (4) rely on the exchanges to settle the transactions. While one may consider such trading experience to be user friendly and simplistic, a user in fact gives away security, privacy, and fairness. As such, a second wave of trading platforms emerged that are known as decentralized exchanges.

While decentralized exchanges are more distributed than centralized exchanges, depending on the technical approach, these exchanges retain, and in some cases exacerbate, some of the issues addressed above. One popular approach is the use of an order book, which lists buy and sell orders. The buy and sell orders are then matched up by the exchanges to complete transactions. In this approach, problems like front running are exacerbated when order books are decentralized because front running can be achieved not only by the operators of the exchange but also by the miners (or validators) that broadcast the transactions onto the blockchain.

In addition to the order book approach, solutions on the market include the use of putting the entire transaction process on-chain as well as other combinations of centralized capabilities on a decentralized platform. These solutions are typically unsuitable for trading DLT-based assets given the decentralized nature of DLT-based assets, e.g., resulting in latency with confirmation time.

### SUMMARY

In view of the foregoing, embodiments of the present disclosure describe a system for a decentralized trading marketplace that leverages the peer-to-peer approach. In particular, trading systems of the present disclosure provide peer-to-peer trading of DLT-based assets. Accordingly, the technical problems of both centralized and decentralized exchanges, as well as the use of order books and on-chain transaction processes, are overcome by embodiments of the present disclosure.

As used herein, the term “asset” encompasses digital assets, such as cryptocurrencies and tokens, as well as non-digital assets implemented in a distributed ledger environment. For example, non-digital assets such as real estate, automobiles, or the like may be implemented in a distributed ledger environment using digital representations of the non-digital assets. Accordingly, embodiments of the present disclosure may use any DLT-based asset even though the examples given herein refer to DLT-based tokens. Similarly, embodiments of the present disclosure may use any digital wallet that holds DLT-based assets even though the examples given herein refer to token wallets.

In one embodiment, the present disclosure describes a system for generating and maintaining a peer-to-peer, distributed ledger technology (DLT)-based asset index. The system may comprise at least one memory storing instructions and at least one processor configured to execute the instructions to perform one or more operations. The operations may comprise receiving, from a plurality of first devices, intent indicators. Each indicator may include a first identifier for a first DLT-based asset and a second identifier for a second DLT-based asset. The operations may further comprise indexing the intent indicators based on the first identifier and the second identifier; receiving, from a second device, a query that includes the first identifier and the second identifier; executing the query against the indexed intent indicators to generate one or more results; in response to the received query, transmitting an order indicator to one or more of the plurality of first devices associated with the one or more results; receiving, from at least one of the one or more first devices, at least one signed order for the first asset and the second asset; and transmitting the at least one signed order to the second device such that the at least one signed order is selectable and executable.

In another embodiment, the present disclosure describes a system for generating and maintaining a peer-to-peer, distributed ledger technology (DLT)-based asset index. The system may comprise at least one memory storing instructions and at least one processor configured to execute the instructions to perform one or more operations. The operations may comprise receiving, from a plurality of first devices, intent indicators. Each indicator may include a first identifier for a first DLT-based asset and a second identifier for a second DLT-based asset; indexing the intent indicators based on the first identifier and the second identifier. The operations may further comprise receiving, from a second device, a query that includes the first identifier and the second identifier; executing the query against the indexed intent indicators to generate one or more results; and transmitting the one or more results to the second device, each result including a signed order for the first DLT-based asset and the second DLT-based asset, wherein each signed order includes a digital signature associated with a corresponding first device such that the one or more results are selectable and the included signed orders are executable.

In additional embodiments, the present disclosure describes non-transitory, computer-readable media for causing one or more processors to execute methods consistent with the present disclosure.

It is to be understood that the foregoing general description and the following detailed description are example and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a block diagram of a peer-to-peer exchange of DLT-based assets.

FIG. 2 is a block diagram of a system for an on-chain order book for DLT-based assets.

FIG. 3 is a block diagram of a system for a peer-to-peer DLT-based asset index, according to an example embodiment of the present disclosure.

FIG. 4 is a block diagram of a system for a peer-to-peer DLT-based asset index, according to an example embodiment of the present disclosure.

FIG. 5 is an example flowchart for generating and maintaining a peer-to-peer DLT-based asset index, according to an exemplary embodiment of the present disclosure.

FIG. 6 is an example flowchart for determining an exchange rate for a peer-to-peer DLT-based asset index, according to an exemplary embodiment of the present disclosure.

### DETAILED DESCRIPTION

The disclosed embodiments relate to systems and methods for generating and indexing of a peer-to-peer DLT-based asset database. Embodiments of the present disclosure may be implemented using a general-purpose computer. Alternatively, a special-purpose computer may be built according to embodiments of the present disclosure using suitable logic elements.

Advantageously, disclosed embodiments may provide technical improvements over centralized exchanges as well as decentralized exchanges on the market. Accordingly, embodiments of the present disclosure may eliminate or reduce flaws with centralized exchanges, avoid the vulnerabilities of implementing order books in a decentralized environment, and remedy the existing issues of having blockchain process large number of transactions.

According to an aspect of the present disclosure, one or more processors of an indexer system (which may comprise one or more servers in a networked architecture) may receive intent indicators. As used herein, an “intent” refers to any desire to enter into an exchange of one asset for another asset, such as one or more first DLT-based assets for one or more second DLT-based assets. Accordingly, an “intent indicator” refers to any portion of data (such as a packet or other bundle of data) that conveys an intent. Each intent indicator may include a first identifier for a first DLT-based asset and a second identifier for a second DLT-based asset. An “identifier” refers to any portion of data (such as a string, a number, or the like) that may be mapped, uniquely, onto a particular type or class of asset.

The indexer may receive the plurality of intent indicators from a plurality of first devices. For example, each first device may comprise a smartphone, a tablet, a laptop, a desktop, or the like. Alternatively, one or more of the first devices may comprise a server. In any of the embodiments above, the first devices may transmit the intent indicators over one or more computer networks, such as the Internet, a local area network (LAN), or the like, and may send the intent indicators using WiFi, 4G, Ethernet, or the like. In some embodiments, one or more of the first devices may send intent indicators over a private network (such as a LAN) and/or may encrypt the intent indicators (e.g., using an Advanced Encryption Standard (AES)).

In some embodiments, each first device may be associated with an address of a token wallet (or other wallet holding digital representations of a DLT-based asset). For example, the first device may include one or more software programs that comprise the token wallet. Additionally or alternatively, the first device may have access to one or more software programs that comprise the token wallet. For example, the token wallet may reside on external hardware (such as a Ledger Nano) communicably connected to the first device. In any of the above embodiments, the token wallet may have one or more unique addresses that may be shared with others in order to receive tokens. Accordingly, the unique address may function to direct transactions to the token wallet analogously to a physical address directing mail to an associated real property.

In some embodiments, the intent indicators may further include a first quantity for the first DLT-based asset and a second quantity for the second DLT-based asset. For example, the intent indicator may indicate an intent to exchange the first quantity of the first DLT-based asset for the second quantity of the second DLT-based asset or vice versa. The first quantity and the second quantity may comprise integer numbers (e.g., 1, 2, 5, etc.) or decimal numbers (e.g., 0.1, 0.5, etc.). The quantity cannot comprise an irrational or complex number.

The indexer may index the received intent indicators based on the first identifier and the second identifier. For example, the indexer may store the intent indicators in a database, such as a relational database, graph database, or the like. Accordingly, the indexer may use the first identifier and the second identifier as indices such that the database may be queried using an identifier, resulting in all stored indicators having a first identifier and/or a second identifier matching the query identifier being returned in response to the query.

In some embodiments, indexing the intent indicators may further include storing (e.g., in the database) the intent indicators and the addresses of the token wallets (or other wallets holding digital representations of a DLT-based asset) associated with the plurality of first devices. In such embodiments, each stored intent indicator may be linked to the address of the wallet associated with one of the plurality of first devices from which the intent indicator was received. Accordingly, each intent indicator may be stored with a corresponding wallet address that indicates the source of the indicator. Furthermore, in such embodiments, the indexer may generate a first index corresponding to the first identifier and a second index corresponding to the second identifier, and may associate the first index and the second index to the corresponding intent indicators stored in the database. Therefore as explained above, the database may be queried using an identifier such that all stored indicators having a first identifier and/or a second identifier matching the query identifier are returned along with the wallet addresses that had been stored with the returned indicators.

Additionally, the indexer may generate a third index corresponding to the addresses of the wallets associated with the plurality of first devices that are linked to the intent indicators. In such embodiments, the indexer may receive a second query including an address and may match the address included in the second query to an address of the third index in order to retrieve intent indicators stored in the database and associated with the matched address based on the third index.

In embodiments where the intent indicators include a first quantity and a second quantity, the indexer may generate indices corresponding to the quantities. In such embodiments, the indexer may match a query having one or more quantities to one or more of the indices corresponding to the quantities in order to retrieve intent indicators stored in the database including the matched quantity (or quantities). This matching may be performed in addition to or in lieu of matching of identifiers and/or wallet addresses.

In some embodiments, the indexer may provide each indexed intent indicator with a unique identifier and generate an index corresponding to the unique identifiers. In such embodiments, the indexer may receive a cancellation command from one of the plurality of first devices, the cancellation command including a unique identifier. The indexer may match the unique identifier included in the cancellation command to an associated unique identifier of the index and delete the intent indicator associated with the matched unique identity.

The indexer may receive, from a second device, a query that includes the first identifier and the second identifier. For example, the second device may comprise a smartphone, a tablet, a laptop, a desktop, or the like. Alternatively, the second device may comprise a server. In any of the embodiments above, the second device may transmit the query over one or more computer networks, such as the Internet, a LAN, or the like, and may send the query using WiFi, 4G, Ethernet, or the like. In some embodiments, the second device may send the query over a private network (such as a LAN) and/or may encrypt the query (e.g., using an Advanced Encryption Standard (AES)).

The indexer may execute the query against the indexed intent indicators to generate one or more results and transmit the one or more results to the second device. The one or more results may comprise the stored intent indicators. In embodiments where the intent indicators are stored with corresponding wallet addresses and/or unique identifiers, the one or more results may further include the addresses and/or unique identifiers.

In response to the received query, the indexer may additionally or alternatively transmit an order indicator to the first devices associated with the one or more results. As used herein, “order” refers to an agreement to exchange of assets between two peers. The “indicator” refers to any portion of data (such as a packet or other bundle of data) that conveys an order. In some embodiments, the order indicator may include an address of a token wallet associated with the second device. Accordingly, the first devices associated with the one or more results may each complete a signed order codifying an order corresponding to the result and return the completed signed order to the indexer. Alternatively, the indexer may generate an order indicator including the order without signatures.

The indexer may thus receive, from at least one of the one or more first devices, at least one signed order for the first asset and the second asset. The indexer may transmit the at least one signed order (or alternatively, at least one unsigned order, as described above) to the second device.

The at least one order may be encapsulated as text or in a graphical user interface. The indexer may transmit the at least one order over one or more computer networks, such as the Internet, a LAN, or the like, and may send the at least one order using WiFi, 4G, Ethernet, or the like. In some embodiments, the second device may send query over a private network (such as a LAN) and/or may encrypt the intent indicators (e.g., using an Advanced Encryption Standard (AES)). As used herein, “transmitting a user interface” refers to any transmission of components (such as graphics, text, style tags, or the like) that may be assembled into a user interface and displayed to a user at a receiving device (e.g., the second device).

In some embodiments, the indexer may order the signed orders prior to transmitting them. For example, the indexer may order the signed orders such that orders having the same corresponding first identifiers, second identifiers, and/or wallet addresses are adjacent within the ordering. Alternatively, the indexer may rank the signed orders. For example, the indexer may rank the orders by one or more quantities. Accordingly, the orders may be ranked by a ratio of the first quantity to the second quantity or vice versa such that the second device may receive a list of orders with the highest/lowest ratio at the top of the list. Other methods of ranking the results may be based on the manner in which the first devices communicate (e.g., ranking an order from a first device with a Bluetooth® connection over an order from a first device with a cellular connection, a maximum/minimum/percentage of assets held, or any combination thereof).

The indexer may transmit the at least one signed order to the second device such that the second device may select and execute the at least one signed order. Accordingly, the second device may select the at least one signed order to complete the at least signed order and may execute it by submitting it to a mining pool (or validator) for finalization. Accordingly, the indexer need not be involved in the codification and execution of the order. Extant systems, such as order books and reserve exchanges, lack this functionality.

As used herein, any of the indices may comprise the corresponding data structure. For example, an index corresponding to the first identifier may comprise the strings, numbers, or the like that comprise the first identifier. Alternatively, an index may comprise a different signifier of the underlying data (such as the first identifier, the second identifier, or the like), such as a graphical representation thereof, a hexadecimal representation thereof, or the like.

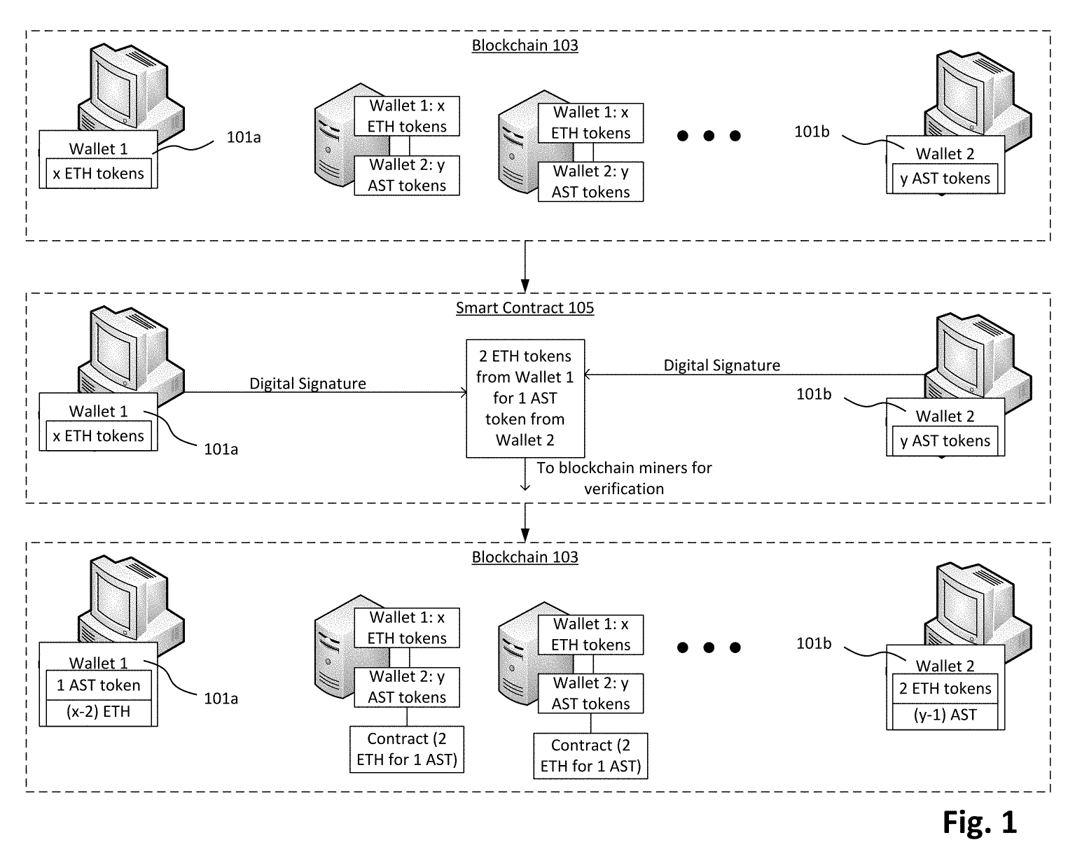

In FIG. 1, there is shown a block diagram of an example peer-to-peer exchange of DLT-based assets. FIG. 1 represents a traditional, manual peer-to-peer exchange of DLT-based assets. As depicted in FIG. 1, a first device 101a may be associated with token wallet with x number of Ethereum tokens (“ETH”). Furthermore, a second device 101b may be associated with a token wallet with y number of AirSwap tokens (“AST”). Because the wallets include DLT-based tokens, the number of tokens in each wallet is verifiable through a distributed ledger, e.g., blockchain 103. Because the ledger is distributed, it is stored across a plurality of devices (such as desktops, laptops, servers, or the like), as depicted in FIG. 1.

To perform a peer-to-peer exchange, first device 101a and second device 101b must both digitally sign a smart contract 105. In the example of FIG. 1, first device 101a and second device 101b sign smart contract 105, thereby agreeing to exchange 2 Ethereum tokens from the wallet associated with first device 101a for 1 AirSwap token from the wallet associated with the second device 101b.

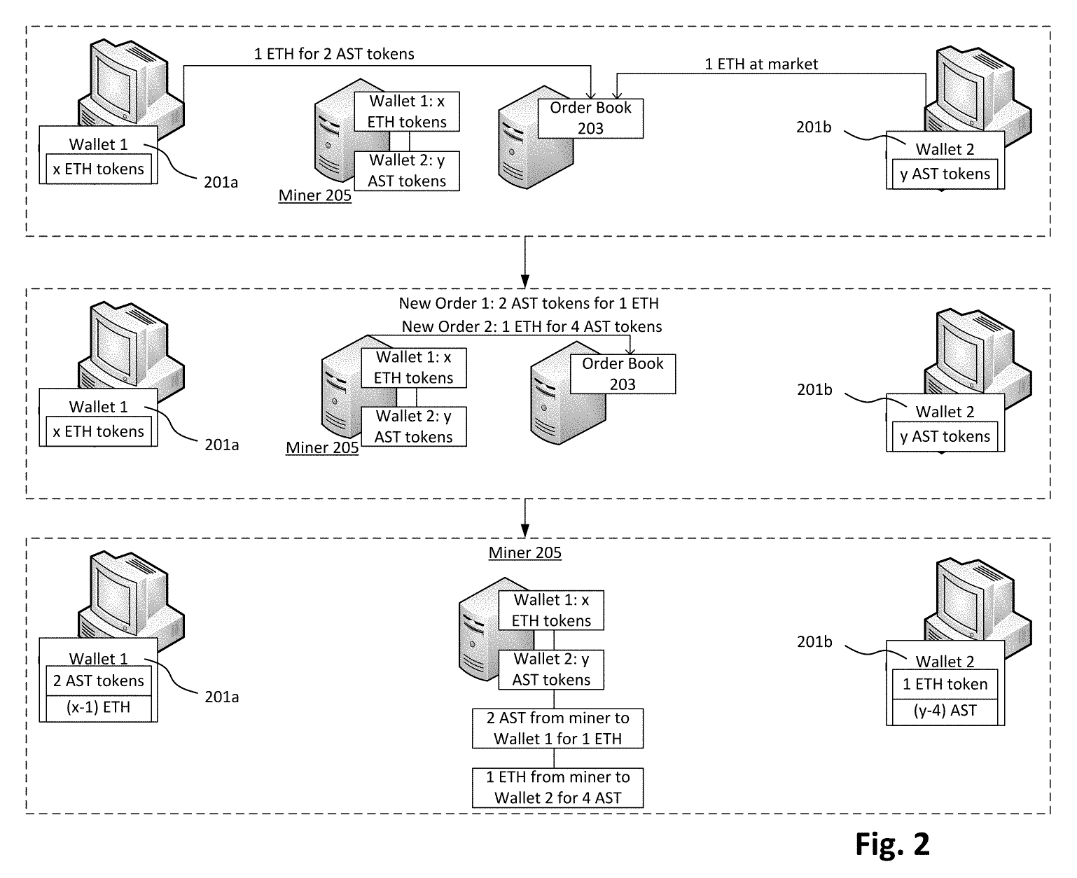

Smart contract 105 is settled by being sent to a mining pool (for DLT-based assets using proof-of-work) or to validators (for DLT-based assets using proof-of-stake). Once finalized, smart contract 105 becomes verifiable through a distributed ledger, e.g., blockchain 103. Although safe and anonymous, this process is manual and cumbersome. One downside to this trading experience is that counterparties must know whom and what to trade with. As a result, systems like FIG. 1 are unscalable to accommodate trading for large number of counterparties and/or assets. Accordingly, solutions like order books have been developed to provide for more scalable exchanges. However, these solutions suffer from technical shortcomings, an example of which is depicted in FIG. 2, described below.

In FIG. 2, there is shown a block diagram of an example system for an on-chain order book for DLT-based assets. While FIG. 2 shows an on-chain order book implementation, order books could also be managed in an off-chain fashion such that, only when settlement occurs, will the transaction be placed onto the blockchain. As shown in the example of FIG. 2, however, problems like front running are exacerbated by use of an order book.

In the example of FIG. 2, a first device 201a may be associated with a token wallet with x number of Ethereum tokens. Furthermore, a second device 201b may be associated with a token wallet with y number of AirSwap tokens. Because the wallets include DLT-based tokens, the number of tokens in each wallet is verifiable through a distributed ledger, e.g., a blockchain. Because the ledger is distributed, it is stored across a plurality of devices (such as desktops, laptops, servers, or the like), e.g., miner 205 as depicted in FIG. 2.

Order book 203 receives sell orders (that is, orders to sell a type of token) and buy orders (that is, order to buy a type of token) from a plurality of devices. In the example of FIG. 2, first device 201a sends an AirSwap token buy order to order book 203, and second device 201b sends an AirSwap token sell order to order book 203. Accordingly, exchanges may match the order from first device 201a and the order from second device 201b because the price of the former (that is, 1 Ethereum token for 2 AirSwap tokens) matches the price of the latter (that is, 1 Ethereum token at market AirSwap token rate).

However, since order book 203 is public in a decentralized environment, front running by those other than the operators of the exchanges, similar to front running on traditional equities markets, becomes a possibility. Moreover, because the ledger is distributed, transactions must be verified by miners (or, in the case of proof-of-stake systems, validators). Miners and validators may thus front load by rearranging the cardinal order in which transactions are processed. Accordingly, as depicted in the example of FIG. 2, miner 205 may insert orders between the order from first device 201a and the order from second device 201b. That is, in the example of FIG. 2, miner 205 may finalize its own order of 2 AirSwap tokens for 1 Ethereum token to finalize an exchange between miner 205 and first device 201a and then may finalize its own order of 1 Ethereum token for 4 AirSwap tokens to finalize an exchange between miner 205 and second device 201b. By doing so, miner 205 has been enriched at the expense of second device 201b, who paid 4 AirSwap tokens for an Ethereum token that only cost 2 AirSwap tokens before miner 205 engaged in front running.

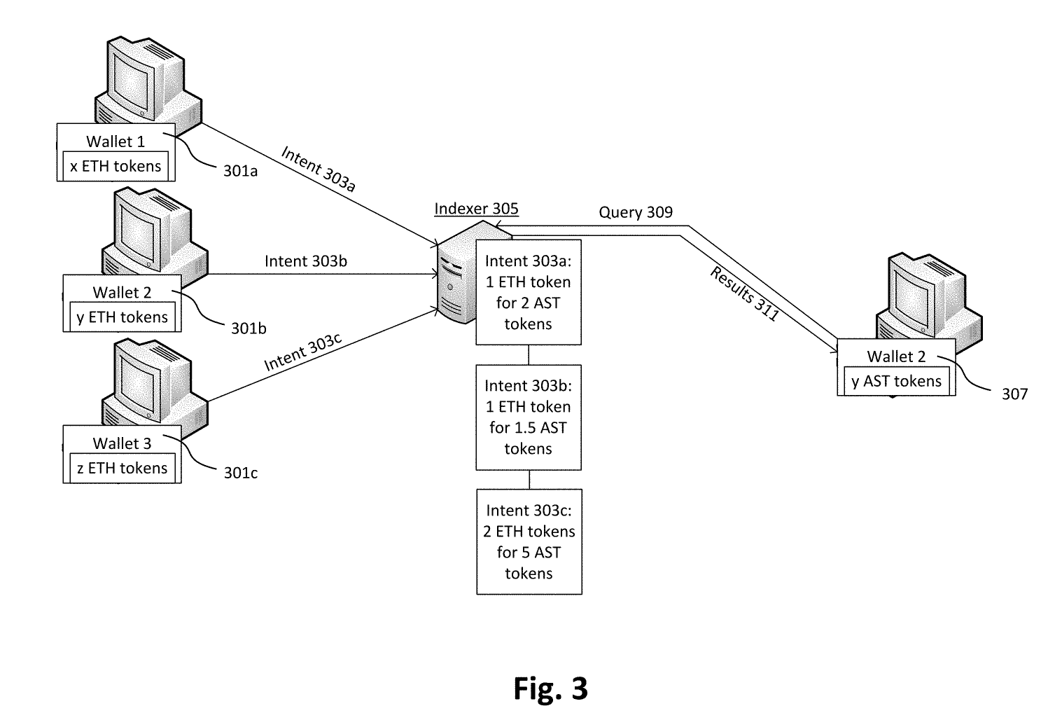

The use of a peer-to-peer DLT-based asset index in accordance with embodiments of the present disclosure minimizes the shortcomings of trading on order books. In FIG. 3, there is shown a block diagram of an example system for a peer-to-peer DLT-based asset index. In the example of FIG. 3, a plurality of first devices, e.g., first devices 301a, 301b, and 301c may have associated wallets, e.g., with x number of Ethereum tokens, y number of Ethereum tokens, and z number of Ethereum tokens, respectively. First devices 301a, 301b, and 301c may send intent indicators, e.g., intent indicators 303a, 303b, and 303c, respectively, to an indexer 305. Indexer 305 may comprise one or more servers that receive intent indicators 303a, 303b, and 303c over one or more computer networks.

As further depicted in FIG. 3, indexer 305 may index the received intent indicators such that they are searchable. For example, the intent indicators may be searchable by a first identifier of a first DLT-based asset and/or a second identifier of a second DLT-based asset. Thus, intent indicator 303a may be searchable by requesting all intent indicators for Ethereum token or all intent indicators for selling Ethereum token. Additionally or alternatively, intent indicator 303a may be searchable by requesting all intent indicators for AirSwap token or all intent indicators for buying AirSwap token. The indexed intent indicators may be searchable by other variables. For example, indexer 305 may render the intent indicators searchable by one or more quantities. In such an example, intent indicator 303a may be searchable by requesting all intent indicators with a quantity of 1, with a quantity of 1 Ethereum token, or with a selling quantity of 1 Ethereum token. Additionally or alternatively, intent indicator 303a may be searchable by requesting all intent indicators with a quantity of 2, with a quantity of 2 AirSwap token, or with a buying quantity of 2 AirSwap token. In another example, indexer 305 may render the intent indicators searchable by wallet address. Accordingly, a query including a wallet address may be processed by indexer 305 to produce all intent indicators from a particular wallet address (indicating that the intent indicators came from one or more particular first devices).

Accordingly, a second device 307 (which may be associated with a token wallet with y number of AirSwap tokens) may send a query 309 to indexer 305. The query may include any number of variables that are searchable in the database storing the intent indicators. After executing the query to obtain results including one or more intent indicators, indexer 305 may return the obtained results to second device 307.

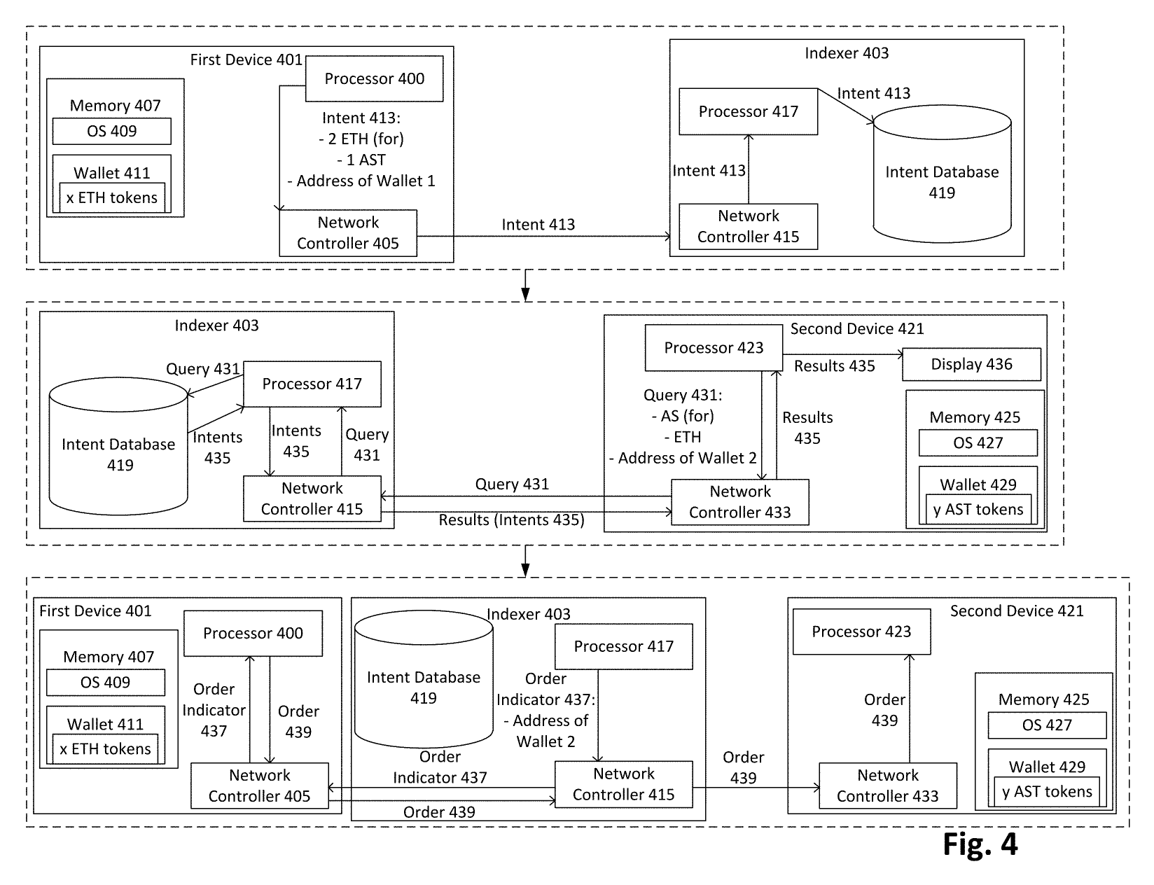

In FIG. 4, there is shown a block diagram of an example system for a peer-to-peer DLT-based asset index. For example, the architecture of FIG. 4 may be used to implement the index and corresponding functionality described in FIG. 3.

As depicted in FIG. 4, a first device 401 may comprise a processor 400 communicably connected to a memory 407 and a network controller 405. Similarly, indexer 403 may comprise a processor 417 communicably connected to a network controller 415 and an intent database 419. Although not depicted in FIG. 4, indexer 403 may further comprise a memory. Any operations performed by processor 400 may be caused by instructions stored in memory 407, instructions stored in a cache of processor 400 (not shown), specific hardware of processor 400 (if processor 400 comprises an application-specific integrated circuit), or any combination thereof. Similarly, any operations performed by processor 417 may be caused by instructions stored in memory (not shown), instructions stored in a cache of processor 417 (not shown), specific hardware of processor 417 (if processor 417 comprises an application-specific integrated circuit), or any combination thereof.

First device 401 may be associated with a wallet 411. Although depicted in memory 407, wallet 411 may also be stored on external hardware or on an external computer and accessed via a bus or network controller 405, respectively. Wallet 411 may hold a particular amount of one or more DLT-based assets. In the example of FIG. 4, wallet 411 holds x number of Ethereum tokens.

Other applications may reside in memory 407. For example, operating system 409 may function to connect hardware of first device 401 (e.g., input devices such as keyboards, mice, touchscreens, or the like and/or output devices, such as displays, speakers, or the like) to software residing in memory 407 (and/or executed by processor 400).

As depicted in FIG. 4, first device 401 may generate an intent indicator 413. For example, processor 400 may generate intent indicator 413 based on input from a user of first device 401. In the example of FIG. 4, intent indicator 413 includes a first identifier (“ETH”) of a first DLT-based asset (Ethereum token) and a second identifier (“AST”) of a second DLT-based asset (AirSwap token). Furthermore, intent indicator 413 further comprises a first quantity (2) for the first DLT-based asset and a second quantity (1) for the second DLT-based asset. Additionally, intent indicator 413 includes an address of wallet 411.

Processor 400 may manually transmit via a user interface or perform an application programming interface (API) call to indexer 403 that results in intent indicator 413 being transmitted by network controller 405 to network controller 415. Moreover, processor 417 of indexer 403 may store intent indicator 413 in a database, e.g., intent database 419. Intent database 419 may index intent indicator 413 using any portion of data included therein, such as the first identifier, the second identifier, the first quantity, the second quantity, the wallet address, or any combination thereof. Additionally or alternatively, processor 417 may assign a unique identifier to intent indicator 413 and may further index intent indicator 413 by the assigned unique identifier.

As further depicted in FIG. 4, a second device 421 may comprise a processor 423 communicably connected to a memory 425 and a network controller 433. In some embodiments, second device 421 may further include a display 426. Any operations performed by processor 423 may be caused by instructions stored in memory 425, instructions stored in a cache of processor 423 (not shown), specific hardware of processor 423 (if processor 423 comprises an application-specific integrated circuit), or any combination thereof.

Second device 421 may be associated with a wallet 429. Although depicted in memory 425, wallet 429 may also be stored on external hardware or on an external computer and accessed via a bus or network controller 433, respectively. Wallet 429 may hold a particular amount of one or more DLT-based assets. In the example of FIG. 4, wallet 429 holds y number of AirSwap tokens.

Other applications may reside in memory 425. For example, operating system 427 may function to connect hardware of second device 421 (e.g., input devices such as keyboards, mice, touchscreens, or the like and/or output devices, such as display 426, speakers, or the like) to software residing in memory 425 (and/or executed by processor 423).

As depicted in FIG. 4, second device 421 may generate a query 431. For example, processor 423 may generate query 431 based on input from a user of second device 421. In the example of FIG. 4, query 431 includes the second identifier (“AST”) and the first identifier (“ETH”). Additionally, query 431 may include an address of wallet 429.

Processor 423 may manually query via a user interface or perform an API call to indexer 403 that results in query 431 being transmitted by network controller 433 to network controller 415. Moreover, processor 417 of indexer 403 may execute query 431 against a database of intent indicators, e.g., intent database 419. The execution may match one or more portions of the query to one or more indexed variables. For example, the first identifier and the second identifier may be match to corresponding indices to produce intents 435 responsive to query 431.

Processor 417 of indexer 403 may transmit intents 435 by network controller 415 to network controller 433. As depicted in the example of FIG. 4, processor 423 of second device 421 may display intents 435 to a user of second device 421. Accordingly, a user of second device 421 may enter input to select one of intents 435. Alternatively, processor 423 may be programmed to automatically select one of intents 435.

In addition to or in lieu of transmitting intents 435, processor 417 may transmit order indicator 437 to first device 401 using network controller 415. Order indicator 437 may, for example, include an address of wallet 429 or any other information necessary to generate order 439. For example, processor 400 of first device 401 may use order indicator 437 to generate a signed order codifying order 439, which reflects the underlying intent represented by intent indicator 413 from first device 401. Alternatively, processor 417 may generate an unsigned order codifying an order that reflects the underlying intent represented by intent indicator 413 from first device 401 and then send order indicator 437 including the unsigned order.

First device 401 may sign the order (generated by processor 400 based on order indicator 437 or generated by processor 417 and included in intent indicator 437). Network controller 405 may then transmit order 439 comprising the signed order to network controller 415 of indexer 403. Indexer 403 may forward order 439 to second device 421 for finalization. Alternatively, first device 401 may reject the order rather than signing it and returning it to indexer 403.

In some embodiments, processor 423 of second device 421 may reject order 439 and send, using network controller 433, a counter-intent (not shown) to network controller 415 of indexer 403. In some embodiments, a counter-intent indicator may be sent to indexer 403 and may include an unsigned or signed order codifying an order reflecting the underlying intent represented by the counter-intent. Accordingly, processor 417 of indexer 403 may transmit a new order indicator (e.g., including a new signed order) generated using the counter-intent or included in the counter-intent indicator to first device 401. First device 401 may then process the new order indicator similar to order indicator 437, described above.

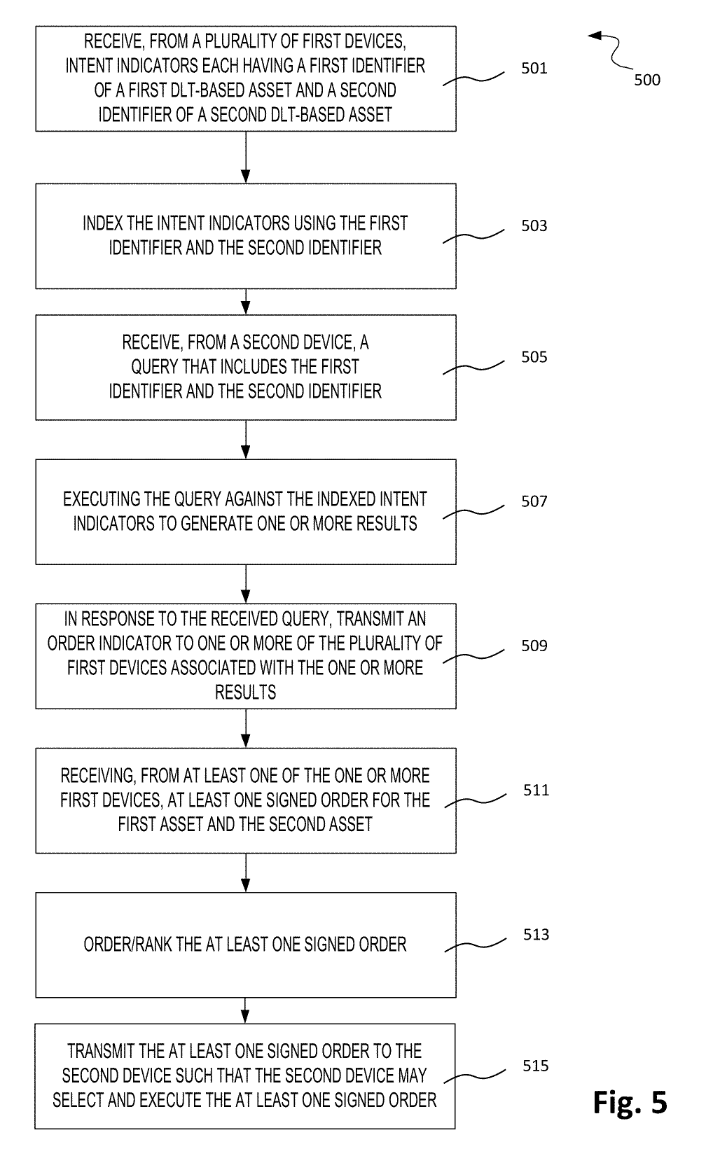

FIG. 5 depicts an example flowchart 500 for generating and maintaining a peer-to-peer DLT-based asset index. Flowchart 500 may be implemented using one or more processors (e.g., processor 417 of indexer 403 of FIG. 4).

At step 501, the one or more processors may receive, from a plurality of first devices, intent indicators. As explained above, each indicator may include a first identifier for a first DLT-based asset and/or a second identifier for a second DLT-based asset. In some embodiments, the intent indicators may further include a first quantity for the first DLT-based asset and a second quantity for the second DLT-based asset. Additionally or alternatively, the intent indicators may include wallet addresses associated with the first devices from which the intent indicators were received.

Alternatively, each indicator may include a first identifier for a first DLT-based asset, a second identifier for a second DLT-based asset, and a signed order for the first DLT-based asset and the second DLT-based asset. In such embodiments, each signed order may have a digital signature associated with a corresponding first device.

At step 503, the one or more processors may index the intent indicators based on the first identifier and/or the second identifier. As explained above, the index may render the intent indicators searchable.

In one example, the one or more processors may store, in a database, the intent indicators and may generate a first index corresponding to the first identifier, generate a second index corresponding to the second identifier, and associate the first index and the second index to the corresponding intent indicators stored in the database.

In embodiments where in the intent indicators include wallet addresses, the one or more processors may store, in the database, the intent indicators and the addresses of the wallets associated with the plurality of first devices. Accordingly, each stored intent indicator may be linked to the address of the wallet associated with one of the plurality of first devices from which the intent indicator was received. In such embodiments, the one or more processors may further generate a third index corresponding to the addresses of the wallets associated with the plurality of first devices that are linked to the intent indicators.

Additionally or alternatively, the one or more processors may provide each indexed intent indicator with a unique identifier, such as a unique string, unique hexadecimal number, unique integer number, unique hash, or the like. In such embodiments, the one or more processors may further generate an index corresponding to the unique identifiers.

At step 505, the one or more processors may receive, from a second device, a query that includes the first identifier and the second identifier. Additionally or alternatively, the query may include other searchable fields, such as one or more wallet addresses and/or one or more quantities.

At step 507, the one or more processors may execute the query against the indexed intent indicators to generate one or more results. In embodiments where the query includes the first identifier and/or the second identifier, the one or more processors may match the first identifier of the query to the first identifier of the first index and/or the second identifier of the query to the second identifier of the second index and retrieve the intent indicators stored in the database and associated with the matched identifier(s) based on the first index and/or the second index. In embodiments where the query includes a wallet address, the one or more processors may match the address included in the query to an address of the third index and retrieve intent indicators stored in the database and associated with the matched address based on the third index.

In some embodiments, the one or more processors may also handle queries from one of the first devices. For example, the one or more processors may receive a cancellation command from one of the plurality of first devices. The cancellation command may include a unique identifier such that the one or more processors may match the unique identifier included in the cancellation command to an associated unique identifier of the index corresponding to the unique identifiers. Accordingly, the one or more processors may delete the intent indicator associated with the matched unique identifier. By allowing first devices to remove intent indicators, the one or more processors may reduce the number of stale intent indicators in the database.

At step 509, in response to the received query, the one or more processors may transmit an order indicator to one or more of the plurality of first devices associated with the one or more results. For example, the one or more processors may, for each result, generate an order indicator reflecting an order that codifies the intent represented by the intent indicator of the result, and send the order indicator to one or more first devices associated with the result. As described above, in some embodiments, the order indicator may include the address of the wallet associated with the second device or any other information necessary to generate an order that codifies the intent represented by a corresponding intent indicator. Alternatively, the one or more processors may generate an unsigned order codifying the intent and include the unsigned order in the order indicator.

At step 511, the one or more processors may receive, from at least one of the one or more first devices, at least one signed order for the first DLT-based asset and the second DLT-based asset. For example, each first device may generate a signed order based on the order indicator received from the one or more processors and return the signed order to the one or more processors. In embodiments where the order indicators include unsigned orders, each first device may sign the included order and return the signed order to the one or more processors.

At step 513, the one or more processors may rank or otherwise order the at least one signed order. For example, the one or more processors may order the signed orders such that signed orders with corresponding intent indicators having the same first identifier, the same second identifier, and/or the same corresponding wallet address may be clustered (i.e., adjacent within the ordering). In another example, in embodiments wherein the intent indicators include one or more quantities, the one or more processors may rank the signed orders by the first quantity, the second quantity, a ratio thereof, or the like of the corresponding intent indicators.

In some embodiments, step 513 may be omitted. For example, the at least one signed order may simply be transmitted in the order of receipt.

At step 515, the one or more processors may transmit the at least one signed order to the second device. For example, as explained above, the at least one signed order may be transmitted as text or in a graphical user interface. The at least one signed order may be transmitted such that the second device may select and execute the at least one signed order. For example, by selecting the at least one signed order on the graphical user interface, the at least one signed order may be executed. The second device may also reject the at least one signed order rather than selecting and executing it.

In embodiments where the intent indicator includes a signed order, the one or more processors may transmit the results including corresponding signed orders rather than transmitting order indicators to first devices. The second device may then sign one or more of the signed orders included in the results and submit the transaction to be finalized by miners and/or a validator. The second device may also reject the one or more signed orders rather than selecting at least one and executing it.

In another alternative embodiment, the one or more processors may transmit the results rather than the signed orders. Accordingly, the one or more processors may order/rank the results or transmit the results in the order they are retrieved from the database. The second device may then select a result. In response to the selection, the second device may send a selection indicator to the one or more processors, and the one or more processor may then send an order indicator, as explained above, to the first device associated with the selected result. Alternatively, the second device may send an unsigned order or a signed order based on the selected result to the one or more processors for forwarding to the first device associated with the selected result.

In any of the examples above, the one or more processors are not involved in matching buyers with sellers or with settlement of the resultant transaction. As illustrated in the above examples, buyers and sellers engage directly with each other to process the resultant transactions.

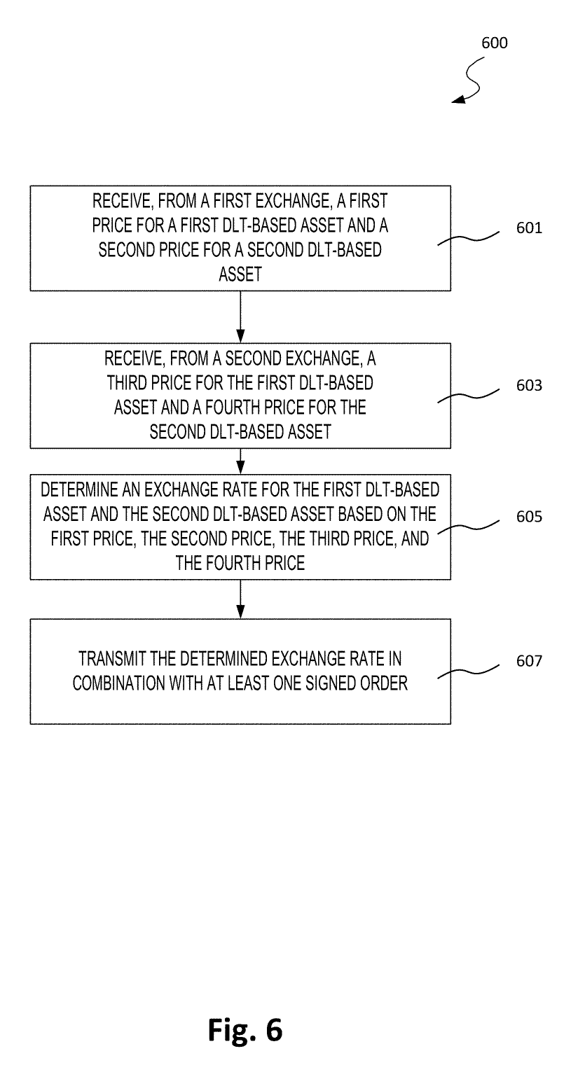

FIG. 6 depicts an example flowchart 600 for determining an exchange rate for a peer-to-peer DLT-based asset index. Flowchart 600 may be implemented using one or more processors (e.g., processor 417 of indexer 403 of FIG. 4).

At step 601, the one or more processors may receive, from a first exchange, a first price for a first DLT-based asset and a second price for a second DLT-based asset. For example, the first price and the second price may be obtained using one or more API calls to the first exchange.

At step 603, the one or more processors may receive, from a second exchange, a third price for the first DLT-based asset and a fourth price for the second DLT-based asset. The third price and the fourth price may be obtained using one or more API calls to the second exchange.

At step 605, the one or more processors may determine an exchange rate for the first DLT-based asset and the second DLT-based asset based on the first price, the second price, the third price, and the fourth price. For example, if the first price represents the price, on the first exchange, of the first DLT-based asset in U.S. dollars, Euros, Chinese Yuan, or the like and the second price represents the price, on the first exchange, of the second DLT-based asset in U.S. dollars, Euros, Chinese Yuan, or the like, the one or more processors may divide the first price by the second price to obtain an exchange rate, on the first exchange, between the first asset and the second asset, or vice versa. The one or more processors may perform a similar calculation for the third price and the fourth price to obtain an exchange rate for the second exchange. The one or more processors may determine the exchange rate by averaging the exchange rate for the first exchange and the exchange rate for the second exchange. The average may be weighted, e.g., by volume on each exchange, by a trust score assigned to each exchange, or the like.

Alternatively, the one or more processors may average the first price and the third price and may average the second price and the fourth price and then determine the exchange rate based on the averaged prices. The averaging may be weighted, e.g., by volume on each exchange, by a trust score assigned to each exchange, or the like.

At step 607, the one or more processors may transmit the determined exchange rate in combination with at least one signed order (or, in embodiments where results are transmitted, with one or more results). For example, the at least one signed order or the one or more results may have been obtained using method 500 of FIG. 5. In embodiments where the at least one signed order or the one or more results are included in a user interface, the one or more processors may update the user interface to include the determined exchange rate. For example, the user interface may include a textual or graphical representation of the determined exchange rate. The one or more processors may then transmit the user interface including the at least one signed order or the one or more results along with the determined exchange rate, e.g., to a second device.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A system for generating and maintaining a peer-to-peer, distributed ledger technology (DLT)-based asset index, comprising:
at least one memory storing instructions; and
at least one processor configured to execute the instructions to perform one or more operations, the operations comprising:
receiving, from a plurality of first devices, intent indicators, each indicator including a first identifier for a first DLT-based asset and a second identifier for a second DLT-based asset;
indexing the intent indicators based on the first identifier and the second identifier;
receiving, from a second device, a query that includes the first identifier and the second identifier;
executing the query against the indexed intent indicators to generate one or more results;
in response to the received query, transmitting an order indicator to one or more of the plurality of first devices associated with the one or more results;
receiving, from at least one of the one or more first devices, at least one signed order for the first asset and the second asset; and
transmitting the at least one signed order to the second device such that the at least one signed order is selectable and executable.

2. The system of claim 1, wherein the received intent indicators further include a first quantity for the first DLT-based asset and a second quantity for the second DLT-based asset.

3. The system of claim 2, wherein the operations further comprise:
ranking the at least one signed order based on the first quantity and the second quantity,
wherein transmitting the at least one signed order comprises transmitting the ranked at least one signed order.

4. The system of claim 2, wherein the operations further comprise:
ranking the at least one signed order based on at least one of the first quantity or the second quantity,
wherein transmitting the at least one signed order comprises transmitting the ranked at least one signed order.

5. The system of claim 1, wherein the operations further comprise:
ordering the at least one signed order,
wherein transmitting the at least one signed order comprises transmitting the ordered at least one signed order.

6. The system of claim 1, wherein the operations further comprise:
generating a user interface that includes the at least one signed order,
wherein transmitting the at least one signed order comprises transmitting the generated user interface.

7. The system of claim 1, wherein each first device is associated with an address of a wallet, and indexing the intent indicators comprises:
storing, in a database, the intent indicators and the addresses of the wallets associated with the plurality of first devices, wherein each stored intent indicator is linked to the address of the wallet associated with one of the plurality of first devices from which the intent indicator was received;
generating a first index corresponding to the first identifier;
generating a second index corresponding to the second identifier; and
associating the first index and the second index to the corresponding intent indicators stored in the database.

8. The system of claim 7, wherein executing the query comprises:
matching the first identifier of the query to the first identifier of the first index;
matching the second identifier of the query to the second identifier of the second index; and
retrieving the intent indicators stored in the database and associated with the matched identifiers based on the first index and the second index.

9. The system of claim 7, wherein indexing the intent indicators further comprises:
generating a third index corresponding to the addresses of the wallets associated with the plurality of first devices that are linked to the intent indicators.

10. The system of claim 9, wherein the operations further comprise:
receiving a second query including an address;
matching the address included in the second query to an address of the third index; and
retrieving intent indicators stored in the database and associated with the matched address based on the third index.

11. The system of claim 1, wherein the operations further comprise:
providing each indexed intent indicator with a unique identifier;
generating an index corresponding to the unique identifiers;
receiving a cancellation command from one of the plurality of first devices, the cancellation command including a unique identifier;
matching the unique identifier included in the cancellation command to an associated unique identifier of the index; and
deleting the intent indicator associated with the matched unique identifier.

12. The system of claim 1, wherein the operations further comprise:
receiving, from a first exchange, a first price for the first DLT-based asset and a second price for the second DLT-based asset;
receiving, from a second exchange, a third price for the first DLT-based asset and a fourth price for the second DLT-based asset;
determining an exchange rate for the first DLT-based asset and the second DLT-based asset based on the first price, the second price, the third price, and the fourth price; and
transmitting the determined exchange rate in combination with the at least one signed order.

13. A system for generating and maintaining a peer-to-peer, distributed ledger technology (DLT)-based asset index, comprising:
at least one memory storing instructions; and
at least one processor configured to execute the instructions to perform one or more operations, the operations comprising:
receiving, from a plurality of first devices, intent indicators, each indicator including a first identifier for a first DLT-based asset and a second identifier for a second DLT-based asset;
indexing the intent indicators based on the first identifier and the second identifier;
receiving, from a second device, a query that includes the first identifier and the second identifier;
executing the query against the indexed intent indicators to generate one or more results; and
transmitting the one or more results to the second device, each result including a signed order for the first DLT-based asset and the second DLT-based asset, wherein each signed order includes a digital signature associated with a corresponding first device, wherein the one or more results are selectable, and wherein the included signed orders are executable.

14. The system of claim 13, wherein the received intent indicators further include a first quantity for the first DLT-based asset and a second quantity for the second DLT-based asset.

15. The system of claim 14, wherein the operations further comprise:
ranking the one or more results based on at least one of the first quantity and the second quantity,
wherein transmitting the one or more results comprises transmitting the ranked results.

16. The system of claim 15, wherein the operations further comprise:
generating a user interface that includes the ranked one or more results,
wherein transmitting the ranked results comprises transmitting the generated user interface.

17. The system of claim 16, wherein the operations further comprise:
receiving, from a first exchange, a first price for the first DLT-based asset and a second price for the second DLT-based asset;
receiving, from a second exchange, a third price for the first DLT-based asset and a fourth price for the second DLT-based asset;
determining an exchange rate for the first DLT-based asset and the second DLT-based asset based on the first price, the second price, the third price, and the fourth price; and
transmitting the determined exchange rate in combination with the one or more results.

18. The system of claim 17, wherein transmitting the determined exchange rate in combination with the one or more results comprises updating the generated user interface with the determined exchange rate and transmitting the generated user interface including the ranked results and the determined exchange rate.
